(19) United States
(12) Patent Application Publication
(10) Pub. No.: US 2006/0039129 A1
(43) Pub. Date: Feb. 23, 2006

(54) Backlight using reversely mounted LEDs

(75) Inventors: William A. Coghlan, Tempe, AZ (US); Mark A. Seelhammer, Chandler, AZ (US); Edward L. Kinnally, Gilbert, AZ (US)

Correspondence Address: CANTOR COLBURN, LLP, 55 GRIFFIN ROAD SOUTH, BLOOMFIELD, CT, 06002, US

(73) Assignee: World Properties, Inc., Lincolnwood, IL (US)

(21) Appl. No.: 10/922,594

(22) Filed: Aug. 20, 2004

(51) Int. Cl. G01D 11/28

(52) U.S. Cl. 362/23; 362/29

(57) ABSTRACT

A display is back lit by reflection of light from at least one point source of light, such as an LED. The reflecting surface can be far, near, or a coating on a package containing the point source of light. The point source of light faces rearwardly, i.e. emitting light away from a viewer, obscuring the source without creating an easily perceptible shadow.

### FIELD OF THE INVENTION

This invention relates to indirect lighting for displays and, in particular, to a display back lit by reversely mounted light emitting diodes (LEDs).

### GLOSSARY

“Point” is not used in the mathematical sense of vanishingly small. A point source of light is a bright source in a small, finite space, “small” being relative to the size of the surrounding structure. Some people may quibble that a point source of light radiates uniformly in all directions. That quibble is not true in practice and does not apply here. As such, incandescent lamps, LEDs, some gas discharge lamps, and others are point sources of light even though, as in the case of LEDs, they radiate in a preferred direction.

Strictly speaking, all non-luminous objects, except black holes, reflect light, otherwise nothing would be visible. A reflecting surface is either specular (a mirror-like or polished surface), uniformly diffuse, or somewhere in-between. At a microscopic level, even a highly polished, front surface mirror is not perfectly specular, nor is any diffuse reflector perfectly lambertian. Mathematical minutiae are of no concern here. Rather the concern is with a macroscopic, practical, diffuse reflector that is reasonably, if not perfectly, lambertian. Many surfaces fulfill this criterion, such as a sheet of white paper or a sheet of white plastic. Obviously, colored paper or plastic filters the light in addition to reflecting the light.

Although the invention is described in the context of an instrument cluster for a vehicle, the invention relates to backlighting any form of display, from something as simple as a switch to something as complicated as the backdrop for a pinball machine. In other words, “display” is meant broadly and “Instrument cluster” is not intended to limit the kinds of display in which the invention can be used.

A “luminous” object emits light. Light incident upon a subject “illuminates” the subject. “Luminance” refers to the amount of light emitted from a source. “Illuminance” refers to the amount of light incident upon a subject.

A “graphic” can be text, a symbol, an arbitrary shape, or some combination thereof. A graphic can be translucent, shaded, colored, a silhouette or outline, or some combination thereof.

As used herein, a “flex circuit” is any type of substrate including conductive traces for including LEDs and other devices in an electrical circuit. As such, a flex circuit includes printed circuit boards. The flexibility of the substrate has no bearing on the invention.

As used herein, an electroluminescent (EL) “panel” is a single sheet including one or more luminous areas, wherein each luminous area is an EL “lamp.” An EL lamp is essentially a capacitor having a dielectric layer between two conductive electrodes, one of which is typically transparent. The dielectric layer can include a phosphor powder or there can be a separate layer of phosphor powder adjacent the dielectric layer. The phosphor powder radiates light in the presence of a strong electric field, using relatively little current.

### BACKGROUND OF THE INVENTION

In the particular display known as an instrument cluster, one either illuminates a dial, e.g. U.S. Pat. No. 2,172,765 (Kollsman) or back lights a mask defining translucent areas corresponding to the dials for gauges or to graphics, such as turn signal indicators; e.g. U.S. Pat. No. 5,578,985 (Cremers et al.).

It is known in the unrelated art of astronomy to make a flat field projector by sandblasting an aluminum plate and illuminating the plate with four LEDs; see Simon Tulloch, Design and Use of a Novel Flat Field Illumination Light Source, Technical Note 108, Instrument Science Group, Royal Greenwich Observatory, 1996.

A diffuse light source, such as an EL panel, is often used for backlighting graphics but is not as luminous as an LED. Some indicators are preferably bright and vivid in color. An LED is generally preferred to an incandescent lamp as a source of light because the LED produces light more efficiently while producing much less heat.

For back lighting, one wants as uniform a light source as possible, and therein lies a problem. LEDs have numerous advantages over incandescent lamps but, like incandescent lamps, are point sources of light. Various forms of light guides or light channels are used to diffuse the light but the fact remains that a point source of light is often visible through the object being backlit. A result is non-uniform lighting. Light from a source that is viewed directly is “glare” and is undesirable.

The need for light guides and the like requires complex structures that are expensive to manufacture, at least for initial tooling.

Another problem with point sources of light, and schemes for diffusing and redirecting the light, is “leakage”; i.e., light from one area being visible in or affecting light in another area. The problem is especially critical for indicators, where only the desired indicator should be back lit while other indicators remain unlit. Related to this is a large, relative to the size of the graphic, minimum separation for indicators to prevent leakage. The minimum separation limits the design of instrument clusters and other displays.

The electronics for most instrument clusters are mounted on flex circuits, where circuit cost is proportional to area, among other factors. Reducing area and simplifying design changes can significantly reduce costs. Design changes can be simplified, for example, if one could change graphics only while using the same flex circuit for the new design.

In view of the foregoing, it is therefore an object of the invention to provide a display, or portion thereof, that is substantially uniformly backlit from a point source of light.

Another object of the invention is to provide an indicator that is substantially uniformly and brightly backlit and vivid in color.

A further object of the invention is to provide a display having areas that are substantially uniformly backlit by LEDs.

Another object of the invention is to provide a display combining EL lamps and reversely mounted LEDs for substantially uniform backlighting.

A further object of the invention is to provide a backlight that is less prone to light leakage and simplifies the construction of complex displays.

### SUMMARY OF THE INVENTION

The foregoing objects are achieved in this invention wherein a display is back lit by reflection of light from a surface illuminated by at least one point source of light, such as an LED. The reflecting surface can be far from the source, near to the source, or even a coating on a package containing the light source. The uniformity of light from the reflecting surface can be changed by shaping the reflecting surface. The point source projects light rearwardly, i.e. away from a viewer. That is, the axis along which light emission is greatest extends from the source away from a viewer. It has been found that the LED itself obscures the point source of light and that the reflected light seen by a viewer does not create a perceptible shadow on the viewer's side of the display.

### BRIEF DESCRIPTION OF THE DRAWINGS

A more complete understanding of the invention can be obtained by considering the following detailed description in conjunction with the accompanying drawings, in which:

FIG. 1 is a plan view of an instrument panel constructed in accordance with the invention;

FIG. 2 is a cross-section of an instrument panel constructed in accordance with the invention;

FIG. 3 is a cross-section of a display constructed in accordance with a preferred embodiment of the invention;

FIG. 4 is a cross-section of a display constructed in accordance with an alternative embodiment of the invention;

FIG. 5 is a cross-section of a display constructed in accordance with another aspect of the invention;

FIG. 6 illustrates another aspect of the invention;

FIG. 7 illustrates yet another aspect of the invention;

FIG. 8 is a chart of light output vs. radius from an LED covered with a diffuse reflective coating.

### DETAILED DESCRIPTION OF THE INVENTION

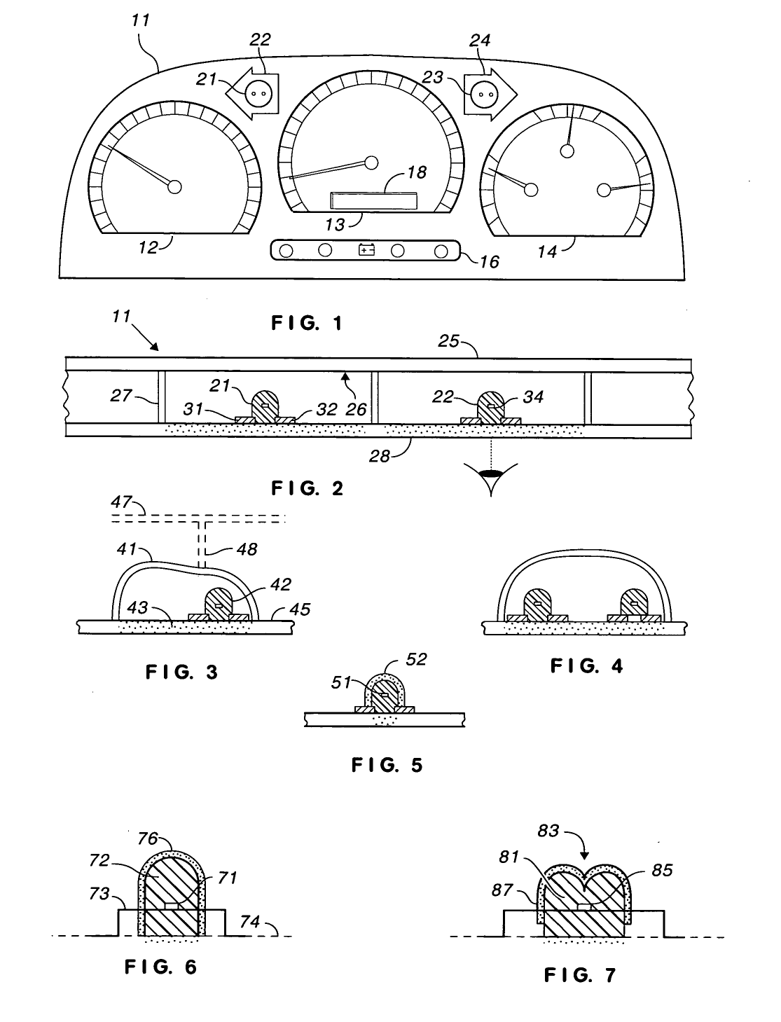

In FIG. 1, display 11 includes gauges 12, 13 and 14 and indicators grouped into area 16. The gauges include pointers that can be illuminated by light piping, as known in the art. The face or dial of each gauge has a translucent area, each preferably back lit by an EL lamp. The EL lamps are preferably part of a single panel. Gauge 12 is a speedometer, for example, and includes odometer 18, which can be a liquid crystal display or a mechanical display fitting behind the front of panel 11. The gauges can include opaque indicia, for example, to contrast with the backlit portions of the dials.

Display 11 further includes LED 21 backlighting turn indicator 22 and LED 23 backlighting turn indicator 24. The LEDs are not shown in proportion to the indicators but are somewhat enlarged to show the leads. As indicated by the position of the leads, LEDs 21 and 23 are reversely mounted; i.e. the direction of greatest light emission is away from the viewer, into the plane of the drawing of FIG. 1.

As illustrated in FIG. 2, display 11 includes backdrop 25 having diffusely reflecting surface 26. The surface is relatively far from the LED, i.e. several diameters away. (“Diameter” refers to the package, not to a semiconductor die.) Display 11 includes struts or supports, such as wall 27, for attaching back drop 25 to flex circuit 28. The struts or supports also serve the additional function of optically isolating LED 21 from other areas of the display. Flex circuit 28 includes a graphics layer that is typically manufactured separately and laminated to the flex circuit. The flex circuit has a plurality of translucent areas, indicated by stippling, that permit light from LEDs 21 and 22 to backlight corresponding graphics. Electrical leads 31 and 32 from LED 21 are attached to the flex circuit, e.g. by soldering.

Semiconductor die 34 in LED 22 emits light predominantly upwardly, as oriented in FIG. 2. There is some scattering as emitted and further scattering as the light emerges from the plastic package enclosing die 34. In this embodiment of the invention, LEDs 21 and 22 have substantially hemispherical ends and any light not incident normal to the air/plastic interface is refracted. Light is further scattered by backdrop 25 and travels in a direction generally opposite to the light emitted from LED 22; i.e., downwardly.

The unexpected result of all this is that turn indicator 24, or any other indicator, is substantially uniformly and brightly backlit. In other words, LED 22 provides high luminance over a wide area (several diameters) without the appearance of a point source. The indicators shown in area 16 (FIG. 1) can be individually back lit in the same manner. Light emitted by the LEDs themselves cannot be seen directly because light is emitted away from a viewer. Thus, there is no “hot spot” or glare in a display constructed in accordance with the invention.

FIG. 3 is a cross-section of a display constructed in accordance with a preferred embodiment of the invention. In FIG. 3, shell 41 surrounds LED 42 to provide backlighting to a small area, represented by stippling 43. The inner (concave) surface of shell 41 is diffusely reflective and is relatively near LED 42; i.e. less than several diameters away from LED 42.

Shell 41 is made from any suitably reflective material. A molded plastic shell is extremely inexpensive and effective. As shown in FIG. 3, LED 42 need not be symmetrically located within shell 41 and shell 41 need not be of uniform shape; i.e. a shape defined, in part, by an axis of rotation. Shell 41 could be molded into a plurality of interconnected volumes to enclose a plurality of LEDs. That is, a shell need not be separately molded for each graphic or indicator.

Optionally, a shell can be molded as part of back cover 47 or attached to the back cover by strut 48.

As also shown in FIG. 4, more than one LED can be contained within a single shell and, if desired, the LEDs can emit different colors, e.g. amber and red, to provide degrees of warning based upon color. Plural LEDs can be driven individually or collectively to provide a variety of visual effects. Displays can be manufactured individually for later assembly or a plurality of shells can be added to flex circuits, or printed circuit boards, after the appropriate LEDs are mounted. In any case, the cost of the display can be reduced, uniformity is increased, and the display can be thinner than in the prior art.

FIG. 5 illustrates another aspect of the invention in which the reflecting surface is a coating on the LED. The range in size, brightness, and color of commercially available LEDs is considerable and the invention can make use of many types of LED.

In FIG. 5, LED 51 has leads extending from the sides, rather than axially, and includes reflector 52 as a coating on the outer surface of the LED. Titania or barium titanate in a suitable resin carrier can be used as the coating. Such material is also known as an ink for depositing a dielectric layer on EL lamps. When cured, the ink provides a white, diffuse, reflective coating. An LED is dipped in the carrier, withdrawn, and the solvent is cured or dried to form an adherent coating of particles suspended in resin. Many materials can be used for the coating.

In one embodiment of the invention, an LED was coated with “white out” or correcting fluid for painting over printed characters or lines on a sheet of paper. The LED functioned as a diffuse backlight. Many other materials can be used instead, such as boron nitride, which is commercially available in the form of a white powder.

FIG. 6 illustrates an LED that has been molded into a plastic package and then coated. LED 71 is a die with leads attached in a small package that has been molded into larger package 72. Leads, such as lead 73, extend from the side of the larger package and are preferably spaced above flex circuit 74, to which the lead is attached. This clearance enables the light diffusely reflecting within coating 76 to fill in any shadow created by LED 71 or the electrical leads extending from LED 71. Reflective coating 76 scatters light from LED 71 downwardly (as oriented in the drawing) for backlighting a graphic on flex circuit 74.

FIG. 7 illustrates an LED constructed in accordance with an alternative embodiment of the invention. Two, independent changes have been made in going from the embodiment of FIG. 6 to the embodiment of FIG. 7. Specifically, the upper surface of package 81 has conical depression 83 molded therein to enhance scattering of the light in the desired direction; namely, downwardly and around the LED to the graphic. The particular contour of the upper surface of LED 81 depends upon the pattern of light emission from die 85 and is determined empirically.

The second change is that coating 87 does not extend down to the plane of the flex circuit. It is preferred that the entire package be coated but this is not required. It is also preferred that the reflector cover substantially 2π steradians of the space around die 85, centered on the axis of greatest emission. Below the die, or below the leads, coating 87 is reflecting reflected light. In some configurations, covering more than 2π steradians is not necessary.

There is a third difference between FIG. 6 and FIG. 7; viz. package 81 is wider than package 72. The size of the package or the height:diameter ratio of the package depends upon application. Wider packages back light wider areas.

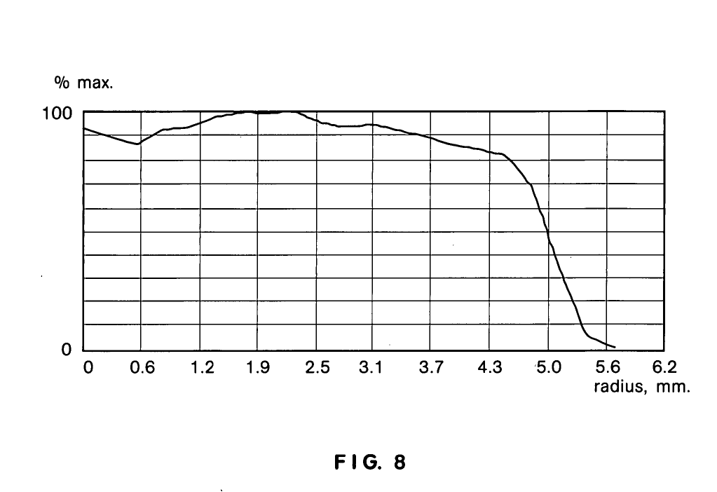

FIG. 8 is a chart generated by a computer model of an LED in a package having a coated, hemispherical upper surface. The chart shows right-hand half of the light from the LED. A mirror-image of the chart, attached along the vertical line at zero radius, would show the light from the left-hand side of the LED. There is a very slight depression near the centerline of the LED, with maximum luminosity at a radius of approximately 2 mm. The unit values along the abscissa are rounded off, which is why they may appear inconsistent. The percent light output is from zero to one hundred percent of maximum.

Light output is substantially uniform almost to a radius of 5 mm, where brightness is about half. Other simulations were run with various shapes for the reflecting surface. An axial depression in the hemisphere produced a doughnut shaped illumination pattern (circular brighter area surrounding and surrounded by dimmer areas.) To enhance the graphic being backlit, the uniformity of the light could be adjusted by shaping the reflector.

The invention thus provides a backlight that is substantially uniformly despite using point sources of light, such as LEDs. The reflecting surface can be far, near, or a coating on the LED. The LED faces rearwardly, i.e. away from a viewer, thereby eliminating glare. Despite the presence of the LED in the field of view, the LED can be positioned to avoid perceptible shadow. Alternatively, an LED can be positioned laterally away from a translucent area and be outside the field of view. An advantage of the shell (FIG. 3) and particularly of the coating (FIG. 5) is that a cascading color can be incorporated into the reflector to enhance color.

Having thus described the invention, it will be apparent to those of skill in the art that various modifications can be made within the scope of the invention. For example, the diffusion coating on an LED can include cascading color materials, such as dyes or phosphors, for enhancing the visual appeal of the display. Large areas can be backlit by plural LEDs or by one or more electroluminescent lamps. The reflecting surface need not be white or of uniform reflectivity.

What is claimed as the invention is:

1. In a display including at least one backlit area, the improvement comprising;
a diffusely reflecting surface;
at least one reversely mounted point source of light illuminating said surface, whereby light reflected from said surface back lights said at least one area without glare.

2. The display as set forth in claim 1 wherein said surface is far from said point source of light.

3. The display as set forth in claim 1 wherein said surface is near said point source of light.

4. The display as set forth in claim 1 wherein said surface is a coating on said point source of light.

5. The display as set forth in claim 4 wherein said coating includes a cascading color.

6. The display as set forth in claim 1 wherein said diffusely reflecting surface is non-planar.

7. The display as set forth in claim 1 wherein more than one point source of light back lights a single back-lit area.

8. In a display including at least one backlit area, the improvement comprising;
a diffusely reflecting surface;
at least one reversely mounted light emitting diode illuminating said surface, whereby light reflected from said surface back lights said at least one area without glare.

9. The display as set forth in claim 8 wherein said surface is far from said light emitting diode.

10. The display as set forth in claim 8 wherein said surface is near said light emitting diode.

11. The display as set forth in claim 8 wherein said surface is a coating on a package containing said light emitting diode.

12. The display as set forth in claim 11 wherein said light emitting diode is contained in a second package and said coating is on the second package.

13. The display as set forth in claim 11 wherein said coating includes a cascading color.

14. The display as set forth in claim 8 wherein said diffusely reflecting surface is non-planar.

15. The display as set forth in claim 8 wherein more than one light emitting diode back lights a single backlit area.

16. The display as set forth in claim 15 wherein a first light emitting diode emits a first color and a second light emitting diode emits a second color.

17. The display as set forth in claim 8 and further including at least a second backlit area and an EL panel for backlighting said second area.

18. In a display including a flex circuit having at least one backlit area, the improvement comprising;
at least one light emitting diode on said flex circuit and emitting light in a first direction away from said flex circuit;
a diffusely reflecting shell enclosing said light emitting diode and said area on said flex circuit, said shell diffusely reflecting light in directions generally opposite said first direction;
whereby light reflected from said shell back lights said at least one area substantially uniformly.

19. In a display including a flex circuit having a plurality of backlit areas, wherein at least one of said areas is backlit by an EL lamp, the improvement comprising;
at least one light emitting diode on said flex circuit and emitting light in a first direction away from said flex circuit;
a diffusely reflecting shell enclosing said light emitting diode and another of said areas on said flex circuit, said shell diffusely reflecting light in directions generally opposite said first direction;
whereby light reflected from said shell back lights said another area substantially uniformly.
